(19) United States
(12) Patent Application Publication
(10) Pub. No.: US 2008/0065855 A1
(43) Pub. Date: Mar. 13, 2008

(54) DMAC Address Translation Miss Handling Mechanism

(76) Inventors: Matthew E. King, Pflugerville, TX (US); Peichun P. Liu, Austin, TX (US); David Mui, Round Rock, TX (US); Mydung N. Pham, Austin, TX (US); Jieming Qi, Austin, TX (US); Thuong Q. Truong, Austin, TX (US)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/531,293

(22) Filed: Sep. 13, 2006

(51) Int. Cl. G06F 12/00; G06F 13/28

(52) U.S. Cl. 711/207; 710/22

(57) ABSTRACT

A memory management unit (MMU) performs address translation and protection using a segment table and page table model. Each DMA queue entry may include a MMU-miss dependency flag. The DMA issue mechanism uses the MMU-miss dependency flag to block the issue of commands that are known to result in a translation miss. However, the direct memory access engine does not block subsequent DMA commands from being issued until they receive a translation miss. When the MMU completes processing of a miss, the MMU sends a miss clear signal to the DMA control unit to reset all MMU-miss dependency flags. When the MMU sends a miss clear signal, the DMA control unit will reset all DMA queue entries with MMU-miss dependency flags set. DMA commands in the DMA queue that were blocked from issue by the MMU-miss dependency flag may now be selected by the DMA control unit for issue.

### BACKGROUND

1. Technical Field

The present application relates generally to an improved data processing system and method. More specifically, the present application is directed to a direct memory address controller address translation miss handling mechanism.

2. Description of Related Art

Many system-on-a-chip (SOC) designs contain a device called a direct memory access (DMA) controller. The purpose of DMA is to efficiently move blocks of data from one location in memory to another. DMA controllers are usually used to move data between system memory and an input/output (I/O) device, but are also used to move data between one region in system memory and another. A DMA controller is called “direct” because a processor is not involved in moving the data.

Without a DMA controller, data blocks may be moved by having a processor copy data piece-by-piece from one memory space to another under software control. This usually is not preferable for large blocks of data. Having a processor copy large blocks of data piece-by-piece is slow, because the processor does not have large memory buffers and must move data in small inefficient sizes, such as 32-bits at a time. Also, while the processor is doing the copy, it is not free to do other work. Therefore, the processor is tied up until the move is completed. It is far better to offload these data block moves to a DMA controller, which can do them much faster and in parallel with other work.

In modern computer systems, the DMA controller (DMAC) makes requests to a memory management unit (MMU) to provide effective address (EA) to real address (RA) translation for a direct memory access (DMA) command. A hit indicates that the MMU successfully translated the EA to a RA. Likewise, a miss indicates that the translation was not found for the EA.

Upon a miss, an interrupt is generated or a tablewalk is performed by the MMU to load the information necessary for translating the missed EA. Many MMU implementations support hit-under-miss operation, which allows translations to continue while the MMU processes a miss, as long as the subsequent translations do not also result in a miss. The DMAC may continue making requests to the MMU, but must keep track of the issued commands and their translation status, which may become cumbersome.

### SUMMARY

The illustrative embodiments recognize the disadvantages of the prior art and provide a direct memory access engine and memory management unit with hit-under-miss capability. A memory management unit (MMU) performs address translation and protection using a segment table and page table model. Each DMA queue entry may include a MMU-miss dependency flag. The DMA issue mechanism uses the MMU-miss dependency flag to block the issue of commands that are known to result in a translation miss. However, the direct memory access engine does not block subsequent DMA commands from being issued until they receive a translation miss. When the MMU completes processing of a miss, the MMU sends a miss clear signal to the DMA control unit to reset all MMU-miss dependency flags. When the MMU sends a miss clear signal, the DMA control unit will reset all DMA queue entries with MMU-miss dependency flags set. DMA commands in the DMA queue that were blocked from issue by the MMU-miss dependency flag may now be selected by the DMA control unit for issue.

In one illustrative embodiment, a method for address translation in a direct memory access control unit is provided. The method comprises selecting, by the direct memory access control unit, a first direct memory access command from a direct memory access queue for issue. The method further comprises responsive to a request for address translation from a direct memory access control unit to a memory management unit for the first direct memory access command, attempting address translation from an effective address to a real address and, responsive to the address translation resulting in a miss, setting a miss dependency flag for the first direct memory access command and performing a lookup operation to load information into a translation look-aside buffer to satisfy the address translation.

In one exemplary embodiment, the method further comprises responsive to the look-up operation completing, sending a miss clear signal from the memory management unit to the direct memory access control unit and, responsive to receipt of the miss clear signal at the direct memory access control unit, resetting the miss dependency flag in all direct memory access queue entries for which the miss dependency flag is set.

In another exemplary embodiment, the method further comprises responsive to receipt of the miss clear signal, selecting, by the direct memory access control unit, the first direct memory access command from a direct memory access queue and reissuing the first direct memory access command.

In a further exemplary embodiment, the method further comprises selecting, by the direct memory access control unit, a second direct memory access command from a direct memory access queue for issue. The direct memory access control unit only blocks commands with the miss dependency flag set.

In a still further exemplary embodiment, the method further comprises responsive to a second request for address translation for the second direct memory access command, attempting a second address translation and, responsive to the second address translation resulting in a miss, setting a miss dependency flag for the second direct memory access command.

In yet another exemplary embodiment, the method further comprises responsive to the second address translation resulting in a hit, returning a real address for the second request for address translation.

In another exemplary embodiment, the method further comprises responsive to the address translation resulting in a hit, returning a real address for the effective address from the memory management unit to the direct memory access control unit.

In another illustrative embodiment, a direct memory access device comprises a direct memory access command queue, a memory management unit, and a direct memory access control unit. The direct memory access control unit selects a first direct memory access command from a direct memory access queue for issue and sends an address translation request to the memory management unit. Responsive to the address translation request, the memory management unit attempts address translation from an effective address to a real address. Responsive to the address translation resulting in a miss, the direct memory access control unit sets a miss dependency flag for the first direct memory access command and the memory management unit performs a lookup operation to load information into a translation look-aside buffer to satisfy the address translation.

In another exemplary embodiment, responsive to the look-up operation completing, the memory management unit sends a miss clear signal to the direct memory access control unit. Responsive to receipt of the miss clear signal, the direct memory access control unit resets the miss dependency flag in all direct memory access queue entries in the direct memory access command queue for which the miss dependency flag is set.

In a further exemplary embodiment, after receipt of the miss clear signal, the direct memory access control unit selects the first direct memory access command from a direct memory access queue and reissues the first direct memory access command.

In a further exemplary embodiment, the direct memory access control unit selects a second direct memory access command from the direct memory access command queue for issue. The direct memory access control unit only blocks commands with the miss dependency flag set. In a still further exemplary embodiment, responsive to a second request for address translation for the second direct memory access command, the memory management unit attempts a second address translation. Responsive to the second address translation resulting in a miss, the direct memory access control unit sets a miss dependency flag for the second direct memory access command. In a still further embodiment, responsive to the second address translation resulting in a hit, the memory management unit returns a real address for the second request for address translation.

In yet another exemplary embodiment, responsive to the address translation resulting in a hit, the memory management unit returns a real address for the effective address to the direct memory access control unit.

In a further illustrative embodiment, a heterogeneous multiprocessor system on a chip comprises a primary processing element, a plurality of secondary processing elements, and a memory flow controller associated with each of the plurality of secondary processing elements. Each memory flow controller comprises a direct memory access command queue, a memory management unit, and a direct memory access control unit. The direct memory access control unit selects a first direct memory access command from a direct memory access queue for issue and sends an address translation request to the memory management unit. Responsive to the address translation request, the memory management unit attempts address translation from an effective address to a real address. Responsive to the address translation resulting in a miss, the direct memory access control unit sets a miss dependency flag for the first direct memory access command and the memory management unit performs a lookup operation to load information into a translation look-aside buffer to satisfy the address translation.

In one exemplary embodiment, responsive to the look-up operation completing, the memory management unit sends a miss clear signal to the direct memory access control unit. Responsive to receipt of the miss clear signal, the direct memory access control unit resets the miss dependency flag in all direct memory access queue entries in the direct memory access command queue for which the miss dependency flag is set.

In a further exemplary embodiment, after receipt of the miss clear signal, the direct memory access control unit selects the first direct memory access command from a direct memory access queue and reissues the first direct memory access command.

In a still further exemplary embodiment, the direct memory access control unit selects a second direct memory access command from the direct memory access command queue for issue. The direct memory access control unit only blocks commands with the miss dependency flag set.

In yet another exemplary embodiment, responsive to a second request for address translation for the second direct memory access command, the memory management unit attempts a second address translation. Responsive to the second address translation resulting in a miss, the direct memory access control unit sets a miss dependency flag for the second direct memory access command.

In another exemplary embodiment, responsive to the address translation resulting in a hit, the memory management unit returns a real address for the effective address to the direct memory access control unit.

These and other features and advantages of the present invention will be described in, or will become apparent to those of ordinary skill in the art in view of, the following detailed description of the exemplary embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an exemplary block diagram of a data processing system in which aspects of the illustrative embodiments may be implemented;

FIG. 2 is a block diagram illustrating a memory flow control unit in accordance with an exemplary embodiment;

FIG. 3 illustrates an example DMA queue entry for a DMA command in accordance with an illustrative embodiment;

FIG. 4 is a flowchart illustrating operation of a memory management unit in accordance with an illustrative embodiment; and

FIG. 5 is a flowchart illustrating operation of a DMA control unit in accordance with an illustrative embodiment.

### DETAILED DESCRIPTION OF THE ILLUSTRATIVE EMBODIMENTS

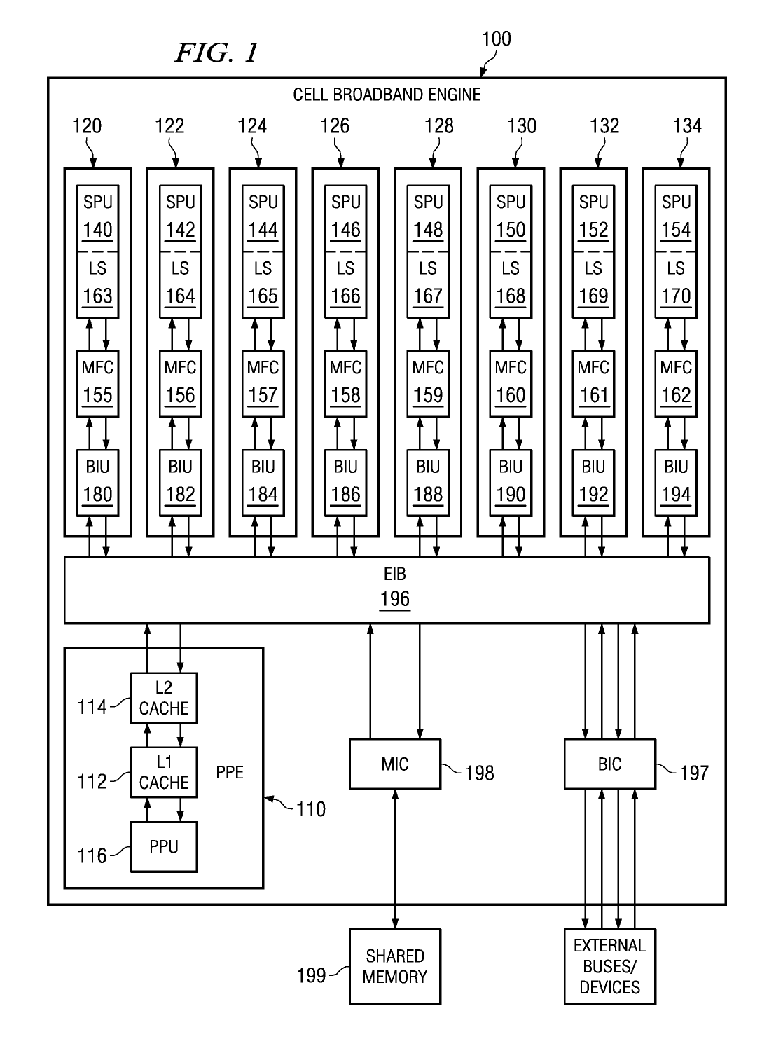

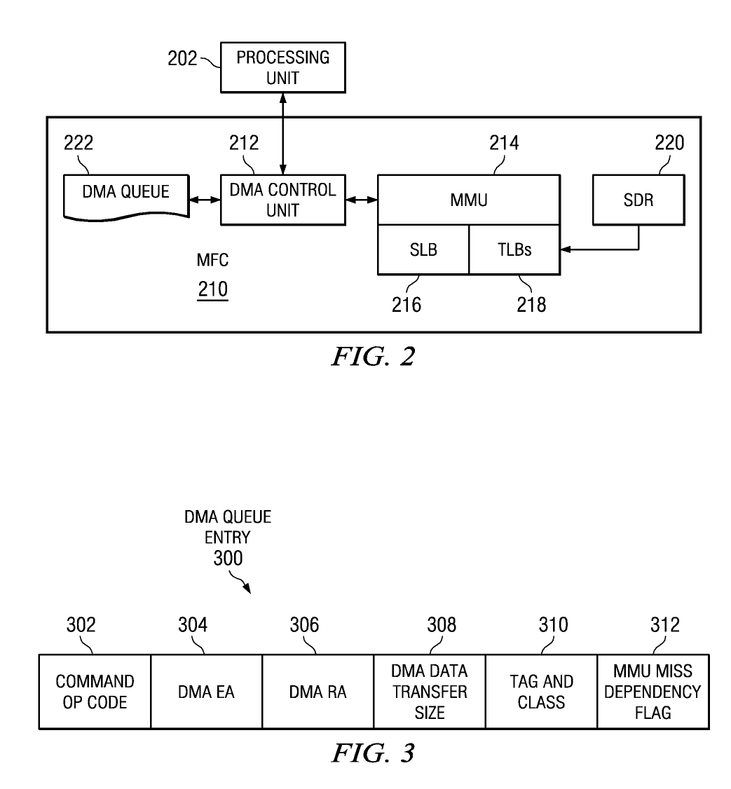

With reference now to the figures and in particular with reference to FIGS. 1-2, exemplary diagrams of data processing environments are provided in which illustrative embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 is an exemplary block diagram of a data processing system in which aspects of the illustrative embodiments may be implemented. The exemplary data processing system shown in FIG. 1 is an example of the Cell Broadband Engine (CBE) data processing system. While the CBE will be used in the description of the preferred embodiments of the present invention, the present invention is not limited to such, as will be readily apparent to those of ordinary skill in the art upon reading the following description.

As shown in FIG. 1, the CBE 100 includes a power processor element (PPE) 110 having a processor (PPU) 116 and its L1 and L2 caches 112 and 114, and multiple synergistic processor elements (SPEs) 120-134 that each has its own synergistic processor unit (SPU) 140-154, memory flow control 155-162 which may contain a direct memory access (DMA) and memory management unit (MMU), local memory or store (LS) 163-170, and bus interface unit (BIU unit) 180-194. A high bandwidth internal element interconnect bus (EIB) 196, a bus interface controller (BIC) 197, and a memory interface controller (MIC) 198 are also provided.

The local memory or local store (LS) 163-170 is a non-coherent addressable portion of a large memory map which, physically, may be provided as small memories coupled to the SPUs 140-154. The local stores 163-170 may be mapped to different address spaces. These address regions are continuous in a non-aliased configuration. A local store 163-170 is associated with its corresponding SPU 140-154 and SPE 120-134 by its address location. Any resource in the system has the ability to read/write from/to the local store 163-170 as long as the local store is not placed in a secure mode of operation, in which case only its associated SPU may access the local store 163-170 or a designated secured portion of the local store 163-170.

The CBE 100 may be a system-on-a-chip such that each of the elements depicted in FIG. 1 may be provided on a single microprocessor chip. Moreover, the CBE 100 is a heterogeneous processing environment in which each of the SPUs may receive different instructions from each of the other SPUs in the system. Moreover, the instruction set for the SPUs is different from that of the PPU, e.g., the PPU may execute Reduced Instruction Set Computer (RISC) based instructions while the SPU execute vectorized instructions.

The SPEs 120-134 are coupled to each other and to the L2 cache 114 via the EIB 196. In addition, the SPEs 120-134 are coupled to MIC 198 and BIC 197 via the EIB 196. The MIC 198 provides a communication interface to shared memory 199. The BIC 197 provides a communication interface between the CBE 100 and other external buses and devices.

The PPE 110 is a dual threaded PPE 110. The combination of this dual threaded PPE 110 and the eight SPEs 120-134 makes the CBE 100 capable of handling 10 simultaneous threads and over 128 outstanding memory requests. The PPE 110 acts as a controller for the other eight SPEs 120-134 which handle most of the computational workload. The PPE 110 may be used to run conventional operating systems while the SPEs 120-134 perform vectorized floating point code execution, for example.

The SPEs 120-134 comprise a synergistic processing unit (SPU) 140-154, memory flow control units 155-162, local memory or store 163-170, and an interface unit 180-194. The local memory or store 163-170, in one exemplary embodiment, comprises a 256 KB instruction and data memory which is visible to the PPE 110 and can be addressed directly by software.

The memory flow control units (MFCs) 155-162 serve as an interface for an SPU to the rest of the system and other elements. The MFCs 155-162 provide the primary mechanism for data transfer, protection, and synchronization between main storage and the local storages 163-170. There is logically an MFC for each SPU in a processor. Some implementations can share resources of a single MFC between multiple SPUs. In such a case, all the facilities and commands defined for the MFC must appear independent to software for each SPU. The effects of sharing an MFC are limited to implementation-dependent facilities and commands.

FIG. 2 is a block diagram illustrating a memory flow control unit in accordance with an exemplary embodiment. Dedicated DMA engines of each processing element of a multi-processing system on a chip, for example, can move streaming data in and out of the local stores of the processing elements in parallel with the program execution. Each memory flow control (MFC) unit 210 has a DMA control unit 212 and a memory management unit (MMU) for a given processing unit 202.

DMA control unit 212 processes a queue 222 of DMA commands. In the Cell Broadband Engine (CBE), there is a PPE-initiated DMA queue and a SPE-initiated DMA queue. For simplicity, one DMA queue 222 is shown in FIG. 2. MFC 210 may be a MFC associated with a SPE in the Cell Broadband Engine of FIG. 1; however, MFC 210 may be any memory controller that uses a MMU for address translation. The exemplary aspects of the illustrative embodiment may apply to any DMA engine and memory management unit with hit-under-miss capabilities.

MMU 214 performs address translation and protection using a segment table and page table model. A DMA transaction may involve a data transfer between a local store address, for example, and an effective address, which can be translated into a system-wide real address using the MFC page table. MMU 214 consists of a segment look-aside buffer (SLB) 216 and translation look-aside buffers (TLBs) 218. SLB 216 is managed through memory mapped input/output (MMIO) registers. The TLBs 218 cache the DMA page table entries. Storage descriptor register (SDR) 220 contains the DMA page table pointer. This architecture allows the PPE and all of the MFCs to share a common page table, which enables the application to use effective addresses directly in DMA operations without any need to locate the real address pages.

In the Cell Broadband Engine, a data transfer from external memory to a SPE local store may be called a DMA GET command, and a data transfer from the SPE local store to external memory may be called a DMA PUT command. The CBE processor supports DMA commands, and the majority of them are variants of GET or PUT. MFC synchronization commands are different from GET/PUT commands. MFC synchronization commands may be used between multiple GET and PUT DMA commands to enforce ordering of DMA transactions relative to each other.

FIG. 3 illustrates an example DMA queue entry for a DMA command in accordance with an illustrative embodiment. DMA queue entry 300 includes a command operation (op) code 302, which can determine the direction of data flow. DMA effective address (EA) 304 is the effective address of the DMA command. DMA queue entry 300 may also include DMA real address 306, which is the 4 K page address translation for EA 304. DMA data transfer size 308 is the size of the block of data to be transferred.

DMA queue entry 300 may also include tag and class 310. The tag identifies the DMA or a group of DMAs. Any number of DMAs can be tagged with the same group. The tag is required for querying completion status of the group. The class is an identifier that determines the resource ID associated with the SPE.

In accordance with an illustrative embodiment, DMA queue entry 300 also includes MMU-miss dependency flag 312. This flag is set or cleared by the result of the MMU translation. The DMA issue mechanism uses MMU-miss dependency flag 312 to block the issue of commands that are known to result in a translation miss. When the MMU completes processing of a miss, the MMU sends a miss clear signal to the DMA control unit to reset all MMU-miss dependency flags.

Returning to FIG. 2, processing unit 202 issues DMA commands to DMA queue 222, and DMA control unit 212 selects a command to issue. DMA control unit 212 makes a translation request to MMU 214 for the issued command and records the result of the translation by setting the MMU-miss dependency flag for a miss and resetting the MMU-miss dependency flag for a hit in the entry corresponding to the issued DMA command.

A miss may occur in either table, SLB 216 or TLBs 218, depending on whether certain parts of the effective address match. The application attempts to load the tables with the correct data. First, MMU 214 goes to the SLB for the segment. If a miss occurs in SLB 216, then the DMA control unit 212 invokes an interrupt to processing unit 202, and the application must fix the SLB. The TLB 218 may have 64 congruent classes, for example. Six bits in the effective address define the congruent class. If the effective address does not match one of the addresses in its congruent class in the TLB 218, then this results in a miss. If there is a miss in the TLB 218, then DMA control unit 212 sets the MMU-miss dependency flag.

For a first miss, MMU 214 will perform a tablewalk to do a page lookup to try to get the correct data in TLB 218. Note, however, that on subsequent misses, the MMU will not perform a tablewalk since one is already in progress. DMA control unit 212 may continue to issue DMA commands from DMA queue 222 as long as there is not a subsequent miss for that queue entry while MMU 214 is performing the tablewalk. For each subsequent miss, the MMU-miss dependency flag is set for that DMA queue entry. When MMU 214 completes the tablewalk, MMU 214 returns a miss clear to DMA control unit 212, which then resets the MMU-miss dependency flag for that command.

One simplification of this mechanism is that DMA control unit 212 may not record which entry corresponds to the miss MMU 214 is processing. When MMU 214 sends a miss clear, DMA control unit 212 resets all DMA queue entries with MMU-miss dependency flags set. DMA commands in DMA queue 222 that were blocked from issue by the MMU-miss dependency flag are now allowed to be selected by DMA control unit 212 for issue.

When the DMA command corresponding to the previous translation miss processed by the MMU is issued, and DMA control unit 212 makes a new translation request to MMU 214, the translation will be a hit. Other DMA commands that had their MMU-miss dependency flags set while MMU 214 was processing the miss may also be selected by DMA control unit 212 for issue. Thereafter, after a miss clear, all DMA commands that were previously blocked due to translation misses can be issued.

Consider an example with five DMA commands in queue, ready to issue. When the DMA device is ready to issue DMA Command 0, for which EA translation is required, the DMA control unit sends an address translation request to the MMU. In this example, the address translation results in a hit. The DMA control unit receives the RA from the MMU, and the DMA device sends the command to the bus interface unit.

Next, when the DMA device is ready to issue DMA Command 1, for which EA translation is required, the DMA control unit sends an address translation request to the MMU. The address translation results in a miss. The DMA device sets the MMU-miss dependency flag of DMA Command 1, and the MMU does a tablewalk (first miss).

Then, when the DMA device is ready to issue DMA Command 2, for which the RA is already valid, the DMA control unit does not make a request to the MMU. The DMA device sends DMA Command 2 to the bus interface unit.

When the DMA device is ready to issue DMA Command 3, for which address translation is required, the DMA control unit sends an address translation request to the MMU. The result of the address translation is a hit. The DMA control unit receives the RA from the MMU, and the DMA device sends the command to the bus interface unit.

Next, when the DMA device is ready to issue DMA Command 4, for which EA translation is required, the DMA control unit sends an address translation request to the MMU. In this example, the result of address translation is a miss. The DMA device sets the MMU-miss dependency flag for DMA Command 4. The MMU does not do a tablewalk for this miss, because a tablewalk is already in progress.

Then, when the DMA device is ready to issue DMA Command 0, for which the RA is already valid, the DMA device sends the command to the bus interface unit. Assuming DMA Command 0 is unrolled into several smaller transfers, this is the second time the command has been unrolled.

Thereafter, the MMU tablewalk completes for DMA Command 1. The MMU sends a miss clear to the DMA control unit, which in turn clears all MMU-miss dependency flags on all entries in the queue. Now all five commands are eligible for issue again.

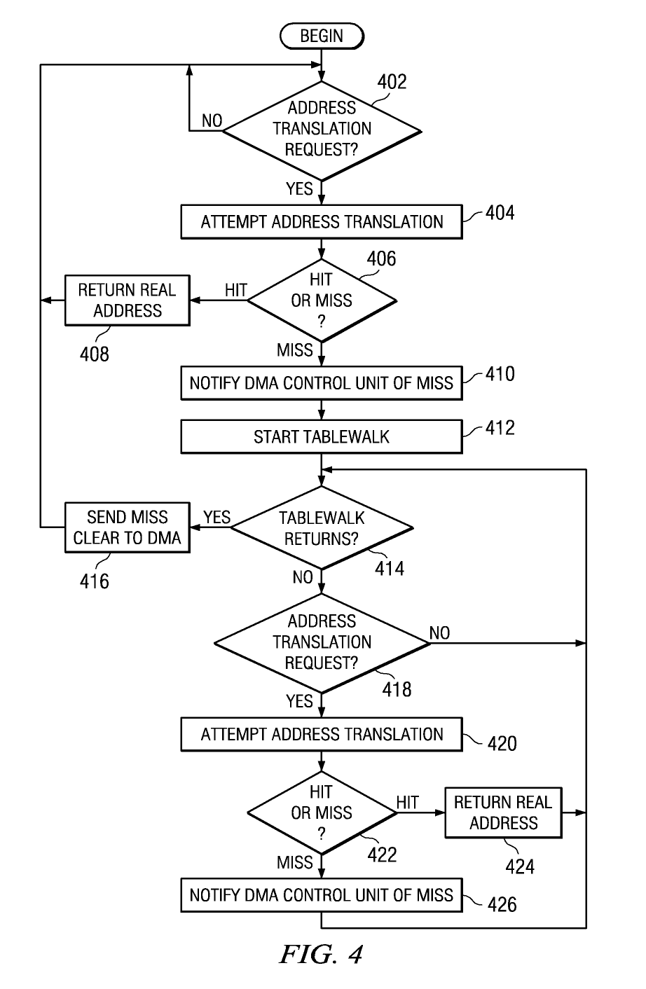

FIG. 4 is a flowchart illustrating operation of a memory management unit in accordance with an illustrative embodiment. It will be understood that each block of the flowchart illustrations, and combinations of blocks in the flowchart illustrations, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems which perform the specified functions or steps, or by combinations of special purpose hardware and computer instructions.

With reference now to FIG. 4, operation begins and the memory management unit determines whether an address translation request is received from the DMA control unit (block 402). If an address translation request is not received, operation returns to block 402 to wait for an address translation request.

If an address translation request is received in block 402, the memory management unit attempts address translation (block 404) and determines whether the address translation results in a hit or miss (block 406). If the address translation results in a hit, the memory management unit returns the real address to the DMA control unit (block 408), and operation returns to block 402 to wait for the next address translation request.

If the address translation attempt results in a miss in block 406, the memory management unit notifies the DMA control unit of the miss (block 410) and starts a tablewalk (block 412). Then, the memory management unit determines whether the tablewalk returns with the page table lookup for the translation look-aside buffer (block 414). If the tablewalk returns, the memory management unit sends a miss clear signal to the DMA control unit (block 416), and operation returns to block 402 to wait for the next address translation request.

If the tablewalk does not return in block 414, the memory management unit determines whether there is a subsequent address translation request while the memory management unit is performing the tablewalk (block 418). If there is not a subsequent address translation request, operation returns to block 414 to determine whether the tablewalk has returned.

If there is a subsequent address translation request in block 418, the memory management unit attempts address translation (block 420) and determines whether the address translation results in a hit or a miss (block 422). If address translation results in a hit, the memory management unit returns the real address (block 424), and operation returns to block 414 to determine whether the tablewalk returns. If the address translation attempt is a miss in block 422, then the memory management unit notifies the DMA control unit of the miss, and operation returns to block 414 to determine whether the tablewalk returns.

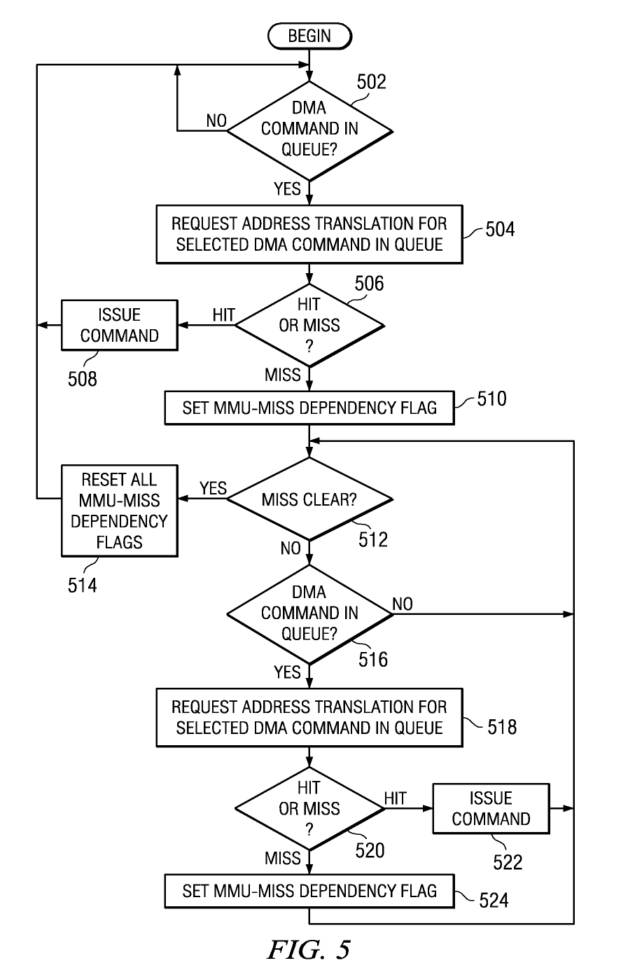

FIG. 5 is a flowchart illustrating operation of a DMA control unit in accordance with an illustrative embodiment. Operation begins and the DMA control unit determines whether there is a DMA command in the DMA queue to issue (block 502). If there is not a DMA command in the queue to issue, operation returns to block 502 to wait for a DMA command that is ready to issue.

If there is a DMA command in the queue in block 502, the DMA control unit makes a request to the memory management unit for address translation for the selected DMA command in the queue (block 504). The DMA control unit determines whether the address translation request resulted in a hit or a miss (block 506). If the address translation is a hit, the DMA control unit issues the command (block 508), and operation returns to block 502 to determine whether there is a DMA command in the queue to issue.

If the address translation is a miss, the DMA control unit sets the MMU-miss dependency flag for the command (block 510). Next, the DMA control unit determines whether the memory management unit returns a miss clear signal (block 512). If the memory management unit returns a miss clear, the DMA control unit resets all MMU-miss dependency flags for all DMA commands in the DMA queue (block 514). Then, operation returns to block 502 to wait for a DMA command to be ready in the DMA queue.

If the memory management unit does not return a miss clear in block 512, the DMA control unit determines whether there is a DMA command in the DMA queue to issue (block 516). If there is not a DMA command in the queue to issue, operation returns to block 512 to determine whether the memory management unit returns a miss clear signal.

If there is a DMA command in the queue in block 516, the DMA control unit makes a request to the memory management unit for address translation for the selected DMA command in the queue (block 518). The DMA control unit determines whether the address translation request resulted in a hit or a miss (block 520). If the address translation is a hit, the DMA control unit issues the command (block 522), and operation returns to block 512 to determine whether the memory management unit returned a miss clear. If the address translation request resulted in a miss, then the DMA control unit sets the MMU-miss dependency flag for the command (block 524), and operation returns to block 512 to determine whether the memory management unit returns a miss clear signal.

Thus, the illustrative embodiments solve the disadvantages of the prior art by providing a direct memory access engine and memory management unit with hit-under-miss capability. A memory management unit (MMU) performs address translation and protection using a segment table and page table model. A direct memory access (DMA) transaction may involve a data transfer between a local store address, for example, and an effective address, which can be translated into a system-wide real address using the MFC page table. Each DMA queue entry may also include a MMU-miss dependency flag. This flag is set or cleared by the result of the MMU translation. The DMA issue mechanism uses the MMU-miss dependency flag to block the issue of commands that are known to result in a translation miss. When the MMU completes processing of a miss, the MMU sends a miss clear signal to the DMA control unit to reset all MMU-miss dependency flags. When the MMU sends a miss clear signal, the DMA control unit will reset all DMA queue entries with MMU-miss dependency flags set. DMA commands in the DMA queue that were blocked from issue by the MMU-miss dependency flag may now be selected by the DMA control unit for issue.

It should be appreciated that the illustrative embodiments may take the form of an entirely hardware embodiment, an entirely software embodiment or an embodiment containing both hardware and software elements. In one exemplary embodiment, the mechanisms of the illustrative embodiments are implemented in software, which includes but is not limited to firmware, resident software, microcode, etc.

Furthermore, the illustrative embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for address translation in a direct memory access control unit, the method comprising:
selecting, by the direct memory access control unit, a first direct memory access command from a direct memory access queue for issue;
responsive to a request for address translation from a direct memory access control unit to a memory management unit for the first direct memory access command, attempting address translation from an effective address to a real address; and
responsive to the address translation resulting in a miss, setting a miss dependency flag for the first direct memory access command and performing a lookup operation to load information into a translation look-aside buffer to satisfy the address translation.

2. The method of claim 1, further comprising:
responsive to the look-up operation completing, sending a miss clear signal from the memory management unit to the direct memory access control unit; and
responsive to receipt of the miss clear signal at the direct memory access control unit, resetting the miss dependency flag in all direct memory access queue entries for which the miss dependency flag is set.

3. The method of claim 2, further comprising:
responsive to receipt of the miss clear signal, selecting, by the direct memory access control unit, the first direct memory access command from a direct memory access queue; and
reissuing the first direct memory access command.

4. The method of claim 1, further comprising:
selecting, by the direct memory access control unit, a second direct memory access command from a direct memory access queue for issue, wherein the direct memory access control unit only blocks commands with the miss dependency flag set.

5. The method of claim 4, further comprising:
responsive to a second request for address translation for the second direct memory access command, attempting a second address translation; and
responsive to the second address translation resulting in a miss, setting a miss dependency flag for the second direct memory access command.

6. The method of claim 5, further comprising:
responsive to the second address translation resulting in a hit, returning a real address for the second request for address translation.

7. The method of claim 1, further comprising:
responsive to the address translation resulting in a hit, returning a real address for the effective address from the memory management unit to the direct memory access control unit.

8. A direct memory access device, comprising:
a direct memory access command queue;
a memory management unit; and
a direct memory access control unit, wherein the direct memory access control unit selects a first direct memory access command from a direct memory access queue for issue and sends an address translation request to the memory management unit,
wherein responsive to the address translation request, the memory management unit attempts address translation from an effective address to a real address,
wherein responsive to the address translation resulting in a miss, the direct memory access control unit sets a miss dependency flag for the first direct memory access command and the memory management unit performs a lookup operation to load information into a translation look-aside buffer to satisfy the address translation.

9. The direct memory access device of 8, wherein responsive to the look-up operation completing, the memory management unit sends a miss clear signal to the direct memory access control unit; and
wherein responsive to receipt of the miss clear signal, the direct memory access control unit resets the miss dependency flag in all direct memory access queue entries in the direct memory access command queue for which the miss dependency flag is set.

10. The direct memory access device of claim 9, wherein after receipt of the miss clear signal, the direct memory access control unit selects the first direct memory access command from a direct memory access queue and reissues the first direct memory access command.

11. The direct memory access device of claim 8, wherein the direct memory access control unit selects a second direct memory access command from the direct memory access command queue for issue, wherein the direct memory access control unit only blocks commands with the miss dependency flag set.

12. The direct memory access device of claim 11, wherein responsive to a second request for address translation for the second direct memory access command, the memory management unit attempts a second address translation; and
wherein responsive to the second address translation resulting in a miss, the direct memory access control unit sets a miss dependency flag for the second direct memory access command.

13. The direct memory access device of claim 12, wherein responsive to the second address translation resulting in a hit, the memory management unit returns a real address for the second request for address translation.

14. The direct memory access device of claim 8, wherein responsive to the address translation resulting in a hit, the memory management unit returns a real address for the effective address to the direct memory access control unit.

15. A heterogeneous multiprocessor system on a chip, comprising:
a primary processing element;
a plurality of secondary processing elements; and
a memory flow controller associated with each of the plurality of secondary processing elements, each memory flow controller comprising:
a direct memory access command queue;
a memory management unit; and
a direct memory access control unit, wherein the direct memory access control unit selects a first direct memory access command from a direct memory access queue for issue and sends an address translation request to the memory management unit,
wherein responsive to the address translation request, the memory management unit attempts address translation from an effective address to a real address,
wherein responsive to the address translation resulting in a miss, the direct memory access control unit sets a miss dependency flag for the first direct memory access command and the memory management unit performs a lookup operation to load information into a translation look-aside buffer to satisfy the address translation.

16. The heterogeneous multiprocessor system on a chip of claim 15, wherein responsive to the look-up operation completing, the memory management unit sends a miss clear signal to the direct memory access control unit; and
wherein responsive to receipt of the miss clear signal, the direct memory access control unit resets the miss dependency flag in all direct memory access queue entries in the direct memory access command queue for which the miss dependency flag is set.

17. The heterogeneous multiprocessor system on a chip of claim 16, wherein after receipt of the miss clear signal, the direct memory access control unit selects the first direct memory access command from a direct memory access queue and reissues the first direct memory access command.

18. The heterogeneous multiprocessor system on a chip of claim 15, wherein the direct memory access control unit selects a second direct memory access command from the direct memory access command queue for issue, wherein the direct memory access control unit only blocks commands with the miss dependency flag set.

19. The heterogeneous multiprocessor system on a chip of claim 18, wherein responsive to a second request for address translation for the second direct memory access command, the memory management unit attempts a second address translation; and
wherein responsive to the second address translation resulting in a miss, the direct memory access control unit sets a miss dependency flag for the second direct memory access command.

20. The heterogeneous multiprocessor system on a chip of claim 15, wherein responsive to the address translation resulting in a hit, the memory management unit returns a real address for the effective address to the direct memory access control unit.
